(19) United States
(12) Patent Application Publication
(10) Pub. No.: US 2009/0096921 A1
(43) Pub. Date: Apr. 16, 2009

(54) Image processing apparatus, method, program, and recording medium

(75) Inventor: Hiroshi Katayama, Chiba (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/151,552

(22) Filed: May 7, 2008

(30) Foreign Application Priority Data
May 29, 2007 (JP) P2007-141369

(51) Int. Cl. H04N 7/04

(52) U.S. Cl. 348/469; 348/E07.04

(57) ABSTRACT

An image processing apparatus includes: digital-source processing means for processing a plurality of digital sources; analog-source processing means for processing a plurality of analog sources; and generation means for generating a clock independently of a clock locked with each input source of the digital sources and the analog sources, and generating a clock in synchronism with a clock selected out of the input sources. The digital-source processing means and the analog-source processing means have individual clock recovery functions independently.

### CROSS REFERENCES TO RELATED APPLICATIONS

The present invention contains subject matter related to Japanese Patent Application JP 2007-141369 filed in the Japanese Patent Office on Mar. 29, 2007, the entire contents of which are incorporated herein by reference.

### BACKGROUND OF THE INVENTION

1. Field of the Invention

The present invention relates to an image processing apparatus, method, program, and recording medium. More particularly, the present invention relates to an image processing apparatus, method, program, and recording medium which are well-suited for use when a plurality of images generated from a plurality of signals are displayed on one screen.

2. Description of the Related Art

In recent years, digital terrestrial television broadcasting has started and is being widespread in addition to analog terrestrial television broadcasting. Also, various broadcasting forms are provided, for example, digital satellite broadcasting via a broadcasting satellite or a communication satellite, cable television (CATV) using a coaxial cable or an optical fiber cable as a communication path, and the like.

Since the number of forms of broadcasting has increased, the number of channels has also increased. Thus, in order for television viewers to easily select channels, there appeared television receivers including a multi-screen display function. In the multi-screen display function, a plurality of channel images are decoded simultaneously, one screen is divided into a plurality of small areas, and the decoded channel images are simultaneously displayed in the individual small areas (refer to Japanese Unexamined Patent Application Publication No. 11-187396).

### SUMMARY OF THE INVENTION

In order to simultaneously display a plurality of images on one screen, it has been necessary to provide a frame synchronizer for synchronizing individual signals. Also, it has been necessary to provide a plurality of memories for processing a plurality of images simultaneously. Also, a delay of a screen image sometimes has occurred. Also, a screen shock has sometimes occurred by the discontinuity of a display synchronization signal.

The present invention has been made in view of these circumstances. It is desirable to make it possible to successfully display a plurality of images on one screen.

According to an embodiment of the present invention, there is provided an image processing apparatus including: digital-source processing means for processing a plurality of digital sources; analog-source processing means for processing a plurality of analog sources; and generation means for generating a clock independently of a clock locked with each input source of the digital sources and the analog sources, and generating a clock in synchronism with a clock selected out of the input sources, wherein the digital-source processing means and the analog-source processing means have individual clock recovery functions independently.

The embodiment of the present invention may further include synthesizing means performing processing for synthesizing a plurality of images out of images based on the plurality of digital sources and images based on the plurality of analog sources, wherein a clock and a synchronization signal of the synthesizing means uses the clock generated by the generation means as a source.

In the embodiment of the present invention, the generation means may generate a decode start signal specifying timing of decoding the digital source and a display synchronization signal.

In the embodiment of the present invention, a decode memory used when decoding the digital sources and a memory for transferring frames of the analog sources are shared.

According to an embodiment of the present invention, there is provided a method of processing an image, including the steps of: controlling digital source processing of a plurality of digital sources; controlling analog source processing of a plurality of analog sources; controlling generation of a clock independently of a clock locked with each input source of the digital sources and the analog sources, and generation of a clock in synchronism with a clock selected out of the input clocks, wherein the step of controlling digital source processing and the step of controlling analog source processing control individual clock recovery functions independently.

According to an embodiment of the present invention, there is provided a program for causing a computer to perform image processing, the processing comprising the steps of: controlling digital source processing of a plurality of digital sources; controlling analog source processing of a plurality of analog sources; controlling generation of a clock independently of a clock locked with each input source of the digital sources and the analog sources, and generation of a clock in synchronism with a clock selected out of the input sources, wherein the step of controlling digital source processing and the step of controlling analog source processing control individual clock recovery functions independently.

According to an embodiment of the present invention, there is provided a recording medium for recording the above-described program.

In an image processing apparatus, method, and program according to an embodiment of the present invention, when a plurality of digital sources and a plurality of analog sources are processed, clock recovery is performed for each source, but a clock is generated independently of the clock recovery, and that clock is used for processing of a plurality of digital sources or a plurality of analog sources.

By an embodiment of the present invention, when a plurality of source images are displayed on a same screen, it becomes possible to continue to supply a display clock and a synchronization signal constantly and stably against changes of input sources and sudden variations such as a signal interruption, etc.

Also, it becomes possible to prevent the occurrence of a discontinuous synchronization signal even when a display clock master has been changed.

### BRIEF DESCRIPTION OF THE DRAWINGS

FIG. 1 is a diagram illustrating a configuration of an image processing apparatus according to an embodiment of the present invention;

FIG. 2 is a diagram illustrating an example of a configuration of a decoder;

FIG. 3 is a diagram for explaining data stored in a frame memory;

FIG. 4 is a diagram for explaining data stored in a frame memory;

FIG. 5 is a diagram for explaining data stored in a frame memory;

and

FIG. 6 is a diagram for explaining a recording medium.

### DESCRIPTION OF THE PREFERRED EMBODIMENTS

In the following, a description will be given of an embodiment of the present invention. The relationship between the constituent features of the present invention and the embodiment described in this specification or the drawings is exemplified as follows. This description is for confirming that an embodiment supporting the present invention is included in the specification or the drawings. Accordingly, if there is an embodiment included in the specification or the drawings, but not included here as an embodiment corresponding to the constituent features of the present invention, the fact does not mean that the embodiment does not correspond to the constituent features of the invention. On the contrary, if an embodiment is included here as constituent features corresponding to the present invention, the fact does not mean the embodiment does not correspond to the constituent features other than that constituent feature.

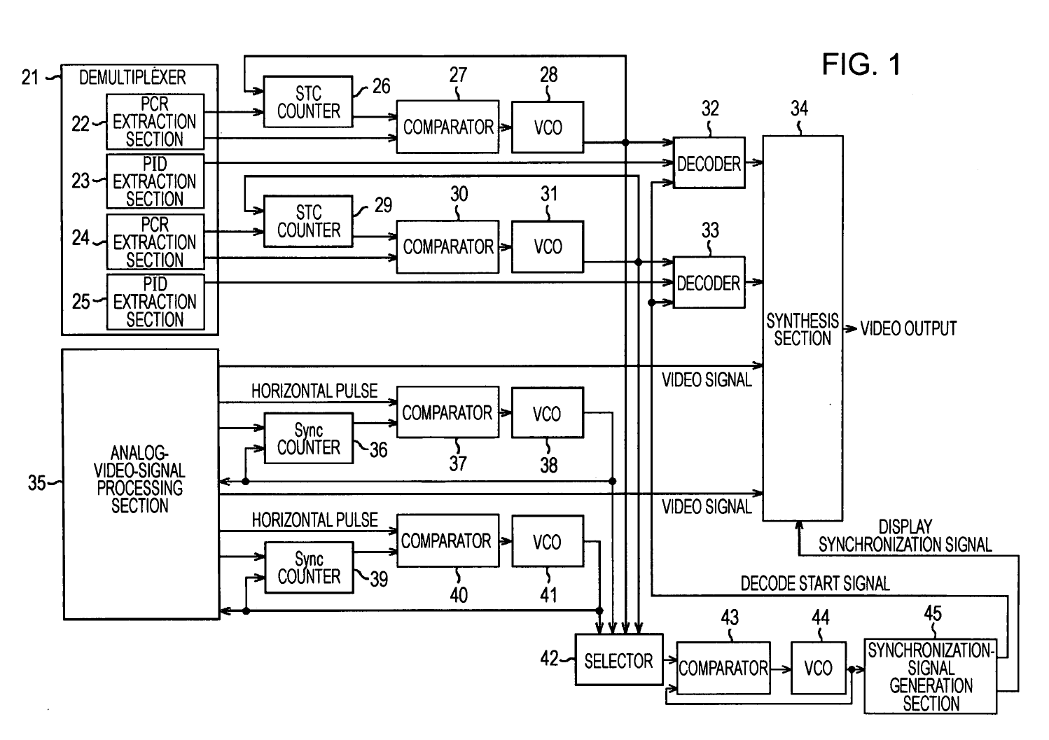

An image processing apparatus (for example, an image processing apparatus in FIG. 1) according to an embodiment of the present invention includes digital-source processing means (for example, a block including a demultiplexer 21, a STC counter 26, a comparator 27, a VCO 28, and a decoder 32 in FIG. 1) for processing a plurality of digital sources, analog-source processing means (for example, a block including a analog-video-signal processing section 35, a Sync counter 36, a comparator 37, and a VCO 38 in FIG. 1) for processing a plurality of analog sources, and generation means (for example, a synchronization-signal occurrence section 45 in FIG. 1) for generating a clock independently of clocks locked with each input source of the digital sources and the analog sources, and generating a clock in synchronism with a clock selected out of the input clocks.

In the following, a description will be given of an embodiment of the present invention with reference to the drawings.

In the following, a description will be given by taking, as an example, the case where a multiplexed transport stream including at least two moving-image signals (in the following, abbreviated as ch1 and ch2) encoded by MPEG (moving picture expert group) are input and processed, and two analog signals (in the following, abbreviated as ch3 and ch4) are input and processed.

FIG. 1 is a diagram illustrating a configuration of an image processing apparatus according to an embodiment of the present invention. The image processing apparatus, shown in FIG. 1, includes a demultiplexer 21, a PCR (program clock reference) extraction section 22, a PID (program ID) extraction section 23, a PCR extraction section 24, a PID extraction section 25, an STC (system time clock) counter 26, a comparator 27, a VCO (voltage controlled oscillator) 28, an STC counter 29, a comparator 30, a VCO 31, a decoder 32, a decoder 33, a synthesis section 34, an analog-video-signal processing section 35, a Sync counter 36, a comparator 37, a VCO 38, a Sync counter 39, a comparator 40, a VCO 41, a selector 42, a comparator 43, a VCO 44, and a synchronization-signal generation section 45.

The demultiplexer 21 separates an encoded image data stream from a transport stream. The PCR extraction section 22 and the PCR extraction section 24 of the demultiplexer 21 separate and extract each PCR, which is reference time information of a channel, from a transport stream. The PID extraction section 23 and the PID extraction section 25 of the demultiplexer 21 separate and extract each PID, which is packet identification information, from a transport stream.

The STC counter 26 reproduces the reference time of a channel to be processed using the PCR supplied from the PCR extraction section 22. The comparator 27 compares a reference time from the STC counter 26 and the PCR from the PCR extraction section 22. Specifically, an error is detected by subtracting one from the other. The VCO 28 generates a system clock, and adjusts the generated system clock on the basis of the error from the comparator 27.

In the same manner, the STC counter 29 reproduces the reference time of a channel to be processed using the PCR supplied from the PCR extraction section 24. The comparator 30 compares a reference time from the STC counter 29 and the PCR from the PCR extraction section 24. Specifically, an error is detected by subtracting one from the other. The VCO 31 generates a system clock, and adjusts the generated system clock on the basis of the error from the comparator 30.

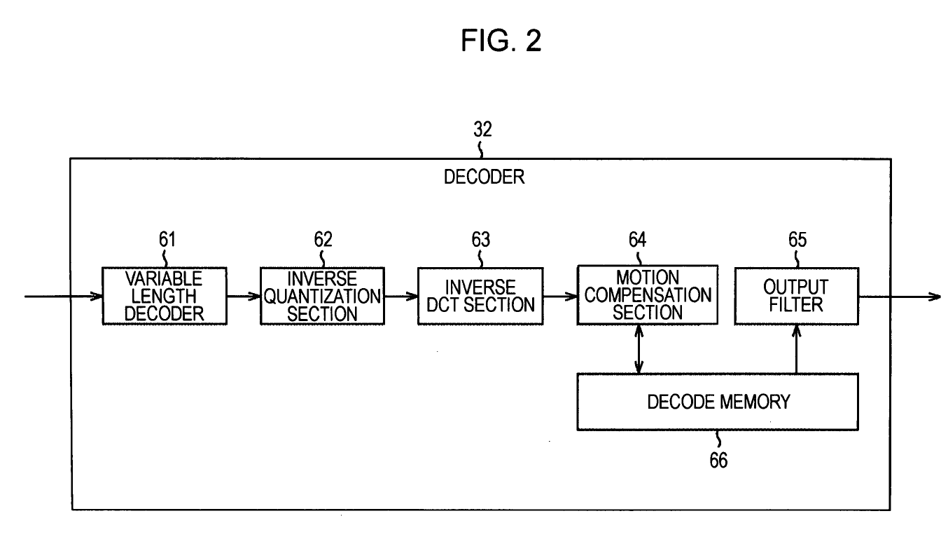

The system clock from the VCO 28 is supplied to the STC counter 26, the decoder 32, and the selector 42. In the same manner, the system clock from the VCO 31 is supplied to the STC counter 29, the decoder 33, and the selector 42. The decoder 32 and the decoder 33 individually have the configuration as shown in FIG. 2.

FIG. 2 is a block diagram illustrating an example of an internal configuration of the decoder 32. The decoders 32 and 33 have the same configuration with each other, and thus a description will be given by taking the decoder 32 as an example. In FIG. 2, the decoder 32 includes a variable length decoder 61, an inverse quantization section 62, an inverse DCT section 63, a motion compensation section 64, an output filter 65, and a decode memory 66.

Although not shown in FIG. 1, an input buffer for storing an image-data bit stream separated by the demultiplexer 21 is provided, and the encoded image data stored in the input buffer is input into the variable length decoder 61. Also, a control signal for controlling each part of the decoder 32 is supplied from the synchronization-signal generation section 45.

Referring back to FIG. 1, the analog-video signal processing section 35 processes a video signal of analog broadcasting. The Sync counter 36 reproduces a reference time of a channel to be processed. The comparator 37 compares the reference time from the Sync counter 36 and a horizontal pulse supplied from the analog-video signal processing section 35 to detect an error. The VCO 38 generates a system clock, and adjusts the generated system clock on the basis of the error from the comparator 37.

In the same manner, the Sync counter 39 reproduces a reference time of a channel to be processed. The comparator 40 compares the reference time from the Sync counter 39 and a horizontal pulse supplied from the analog-video signal processing section 35 to detect an error. The VCO 41 generates a system clock, and adjusts the generated system clock on the basis of the error from the comparator 40.

System clocks from the VCO 28, the VCO 31, the VCO 38, and the VCO 41 are input to the selector 42. The selector 42 selects a system clock to be a master from the input system clocks, and outputs the system clock to the comparator 43. The system clock selected by the selector 42 is the system clock corresponding to the channel that has been set as a master by the user. Also, for example, when it is assumed that two channel images are simultaneously displayed on a screen, and the channel of the image displayed on the right side is set to be a master, etc., the system clock corresponding to the channel of the image displayed on the right side is set to be a master, and the user is allowed to set which channel is displayed on the right side.

The system clock from the VCO 44 is fed back to the comparator 43. The comparator 43 calculates an error between the two system clocks, and supplies it to the VCO 44. The VCO 44 generates a system clock adjusted on the basis of the supplied error, and supplies the system clock to the comparator 43 and to the synchronization-signal generation section 45. The synchronization-signal generation section 45 generates a display synchronization signal on the basis of the supplied system clock and a decode start signal common to the channels. The decode start signal generated by the synchronization-signal generation section 45 is supplied to the decoder 32 and the decoder 33, and the display synchronization signal is supplied to the synthesis section 34.

The decoder 32 and the decoder 33 starts the decoding of the encoded image data stored in the input buffer, and supplies the decoded image data to the synthesis section 34. The synthesis section 34 synthesizes a predetermined images out of the ch1 image from the decoder 32, the ch2 image from the decoder 33, the ch3 image and the ch4 image from the analog-video-signal processing section 35, and outputs the result to a display not shown in the figure.

Next, a description will be given of the operation of the image processing apparatus of FIG. 1. In the following description, the PCR extraction section 22 and the PCR extraction section 24 perform the same processing, and thus a description will be given by taking the PCR extraction section 22 as an example unless it is necessary to distinguish them in particular. Also, in the same manner, a description will be given of the operation for processing digital broadcasting by taking the PID extraction section 23, the STC counter 26, the comparator 27, the VCO 28, and a decoder 32 as an example. For the operation of processing analog broadcasting, a description will be given by taking the Sync counter 36, the comparator 37, and the VCO 38 as an example.

An input transport stream is separated into two-channel encoded image data streams on the basis of the packet identification information (PID) in the transport stream by the demultiplexer 21, is stored into an input buffer disposed for each channel, and is decoded by the decorders 32 and 33 for each channel.

Here, it is assumed that the ch1 image signal is decoded by the decoder 32 by referencing the system clock generated by the VCO 28 and the decode start signal generated by the synchronization-signal generation section 45. In the same manner, it is assumed that the ch2 image signal is decoded by the decoder 33 by referencing the system clock generated by the VCO 31 and the decode start signal generated by the synchronization-signal generation section 45. In this embodiment, in this manner, the reference times are supplied from the VCO 28 and the VCO 31 by the individually corresponding decoder 32 and decoder 33, but the decode start signal is both supplied by the decode start signal generated by the synchronization-signal generation section 45, and the decoder 32 and the decoder 33 start decoding processing individually on the basis of the decode start signal.

Thus, the PCR clock recovery mechanism which is carried out generally by the MPEG decoding processing is achieved by providing the STC counters 26 and 29, the comparators 27 and 30, and the VCOs 28 and 31, whereas the control signal (decode start signal) giving the decoding timing of the MPEG decoders 32 and 33 is not supplied by the synchronization signal based on the clock signal recovered by each MPEG source PCR, but is supplied by the signal independently generated by the synchronization-signal generation section 45.

The synchronization-signal generation section 45 generates the decode start signal and the display synchronization signal on the basis of the system clock selected by the selector 42. The selector 42 selects any one system clock from the VCO 28 generating the ch1 system clock, the VCO 31 generating the ch2 system clock, the VCO 38 generating the ch3 system clock, and the VCO 41 generating the ch4 system clock.

Thus, the synchronization-signal generation section 45 generates the decode start signal and the display synchronization signal dependently on the system clock generated by any one VCO from the VCO 28, the VCO 31, the VCO 38, or the VCO 41. To put it another way, the synchronization-signal generation section 45 generates the decode start signal and the display synchronization signal using any one channel signal out of the ch1, the ch2, the ch3, or the ch4 as a master.

In this manner, it becomes possible for the synthesis section 34 to have a configuration not necessitating a frame synchronizer. Also, in an image processing apparatus according to the present embodiment, the clock of the synchronization-signal generation section 45 generating the display synchronization signal is independent of each digital source and the demodulation clock of each analog source. Thus, it is possible to continue to supply the display clock and the synchronization signal constantly and stably against changes of input sources and sudden variations such as a signal interruption, etc.

Also, even when a display clock master is changed, the display synchronization signal is locked with each input source by PLL (phase-locked loop), and thus it becomes possible to obtain a synchronization without the occurrence of the discontinuous synchronization signal.

Moreover, a description will be given of the operation of the image processing apparatus shown in FIG. 1.

An input transport stream is separated into two-channel encoded image data streams on the basis of the packet identification information (PID) in the transport stream by the demultiplexer 21, and is stored into an input buffer disposed for each channel, and is decoded by the decorders 32 and 33 for each channel. Also, the analog-video signal processing section 35 includes an A/D (Analog/Digital) signal processing section, converts the supplied analog video signal into a digital signal, outputs the video signal to the synthesis section 34, supplies a horizontal pulse, etc., to the comparator 37 and the comparator 40, and the like.

When the synthesis section 34 synthesizes 4-channel images, that is to say, in this case, the 4-channel images including 2-channel digital images and 2-channel analog images are synthesized. In this case, the image of each channel is necessary to be processed, and thus the image of each channel is processed by each channel. For example, when 2-channel images are synthesized, the selected 2-channel images are processed by the individual channels.

For example, when 2-channel digital broadcasting is synthesized, the ch1 and ch2 images, which are output from the decorders 32 and 33, respectively, are synthesized, and thus the parts necessary for the decorders 32 and 33 to perform individual processing are activated for processing. To put it in another way, in this case, the parts related to the analog-video signal processing section 35 are not processed. In this manner, only the parts for processing the images selected by the user should be activated.

Here, a description will be given of the case where the ch1 image and the ch2 image are displayed on one screen, that is to say, 2-chnnel images of digital broadcasting are displayed on the same screen. Also, here, a description will be given of a reproducing operation when the master stream is set to ch1.

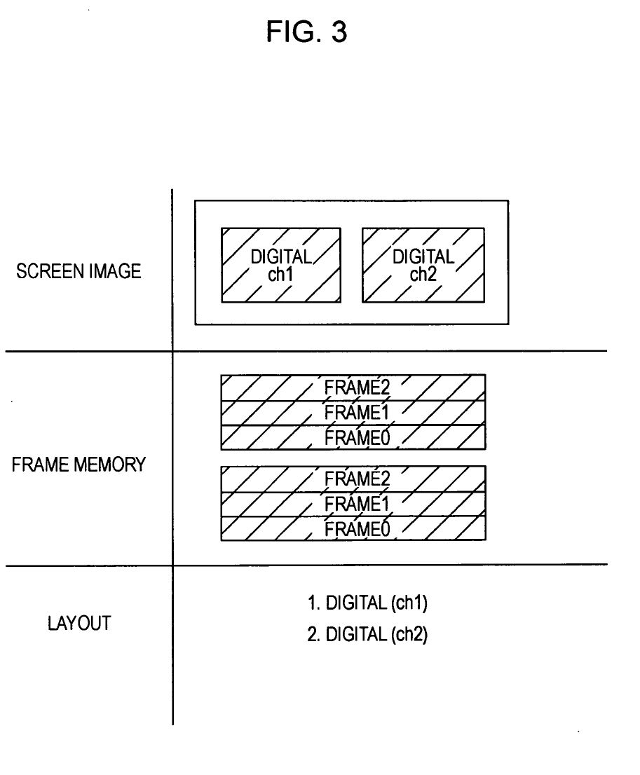

In this case, as shown in FIG. 3, the screen image is in a state in which the ch1 image of the digital broadcasting and the ch2 image of the digital broadcasting are displayed on the same screen. Also, at this time, the frames 0 to 2 for the ch1 and the frames 0 to 2 for the ch2 are stored in the frame memory. That is to say, the data for displaying the ch1 digital broadcasting screen and the data for displaying the ch2 digital broadcasting screen are disposed in the frame memory. In this case, the frame memory is used for processing the digital broadcasting.

The PCR extraction section 22 extracts the PCR information included in the ch1 stream from the bit stream input into the demultiplexer 21, and the value of the PCR is output to the STC counter 26. The STC counter 26 receives the ch1 stream, and when the first PCR is received, this value is loaded to the counter, and the STC counter 26 is operated using the system clock output from the VCO 28.

Next, when the PCR extraction section 22 extracts the ch1 PCR again, the extracted ch1 PCR value and the ch1 STC count value counted by the STC counter 26 are output to the PLL constituted by the comparator 27 and the VCO 28, and the system clock locked with the ch1 stream is reproduced. In the following, in the same manner, the difference value is reflected on the PLL, and thus a stable system clock continues to be reproduced.

In the same manner, the PCR extraction section 24 extracts the PCR information included in the ch2 stream from the bit stream input into the demultiplexer 21, and the value of the PCR is output to the STC counter 29. The STC counter 29 receives the ch2 stream, and when the first PCR is received, this value is loaded to the counter, and the STC counter 29 is operated using the system clock output from the VCO 31.

Next, when the PCR extraction section 24 extracts the ch2 PCR again, the extracted ch2 PCR value and the ch2 STC count value counted by the STC counter 29 are output to the PLL constituted by the comparator 30 and the VCO 31, and the system clock locked with the ch2 stream is reproduced. In the following, in the same manner, the difference value is reflected on the PLL, and thus a stable system clock continues to be reproduced.

In this manner, the system clocks of the ch1 and ch2 continue to be reproduced individually. Such processing is performed, and at the same time, the following processing is performed. That is to say, the ch1 system clock from the VCO 28 and the ch2 system clock from the VCO 31 are individually supplied to selector 42. The selector 42 selects the system clock set as a master stream at that point in time, in this case, the ch1 system clock, which is supplied from the VCO 28, and outputs it to the comparator 43.

The comparator 43 and the VCO 44 constitute a PLL, and in this case, the comparator 43 and the VCO 44 reproduces a system clock locked with the ch1 master clock. The system clock is produced by reflecting the difference value on the PLL, and thus is produced as a stable system clock.

The system clock from the VCO 44 is supplied to the synchronization-signal generation section 45. The synchronization-signal generation section 45 generates the decode start signal and the display synchronization signal from the system clock synchronized with the master stream. The synchronization-signal generation section 45 divides the system clock supplied from the VCO 44 by a counter and a frequency divider, and thereby generates the decode start signal and vertical and horizontal display synchronization signals.

Originally, this decode start signal should be controlled so as to be in synchronism with the decode-start time information (DTS) included in the master stream. However, in the present invention, the DTS is not used, and the decode start signal is generated with a phase uniquely determined by the display system using a system clock. Accordingly, even if the master stream is changed from the ch1 to the ch2, the decode start signal can be generated with a certain phase constantly regardless of the phase of the decode-start information included in the ch. Also, the cycle of the decode start signal can be matched with the frame rate of the master stream. That is to say, if the master stream is changed, it is possible to change the frame rate of the master stream whose decode start signal cycle has been changed.

Next, a description will be given of a decode-start operation in the decorders 32 and 33 to which the decode start signal generated in this manner is supplied. When the decode start signal, which is common to the channels, generated in the above-described method is input into the decorders 32 and 33 individually, the PTS values and the STC values are compared individually at this timing.

As a result of this comparison, if the PTS value is less than the STC value, the decoding of the current frame is started by the corresponding decorder at the timing of the decode start signal. Here, if the PTS value is less than the STC value by one frame or more, the decoding is stopped until a frame whose PTS value is greater than STC value. If the PTS value is greater than the STC value, the decoding operation is stopped until the next decode start signal is input.

In this manner, for example, when the two digital broadcasting programs of the ch1 and the ch2 are displayed on one screen, the display synchronization signal is synchronized with the clock recovered by the ch1. In this case, for ch1, the operation is performed in the same manner as the MPEG synchronization reproducing mechanism, and the PCR clock recovery of the ch2 is also performed. However, the decoding timing can be synchronized with the ch1 clock, and the output-image timing of the MPEG decorder 33 of the ch2 can be made the same as the output-image timing of ch1. Thus, it becomes possible for the synthesis section 34 to have a configuration not necessitating a frame synchronizer.

In this regard, the clock frequencies of the ch1 and the ch2 are originally different, and thus the difference between the PTS and the STC of the ch2 decorder 33 might expand by compulsorily matching the decoding timing with that of the ch1. As described above, at the point in time when this difference becomes one frame or more, an adjustment is made by performing the image skip processing or the image repeat processing.

In this manner, by the present embodiment, video signals having different frame frequencies are not synchronized by a frame synchronizer, but it becomes possible to compulsorily match one frame rate to the other frame rate by the skip/repeat processing of the MPEG decoding processing.

Next, a description will be given of the case where the ch1 image and the ch3 image are displayed on one screen, that is to say, 1-chnnel image of digital broadcasting and 1-chnnel image of analog broadcasting are displayed on the same screen. In this case, the basic operations include the same operation of the case where 2-channel digital broadcasting are displayed on one screen as described above, and thus a brief description will be given on that part.

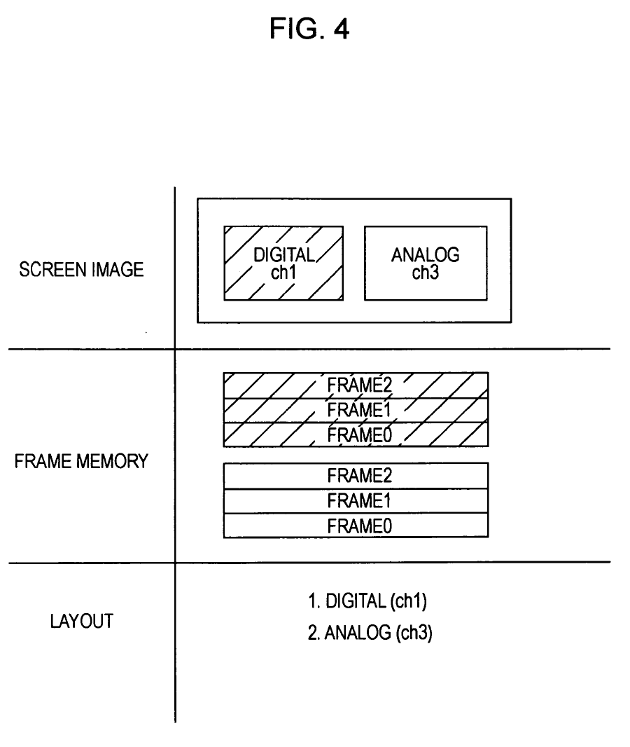

In this case, as shown in FIG. 4, the screen image is in a state in which the ch1 image of the digital broadcasting and the ch3 image of the analog broadcasting are displayed on the same screen. Also, at this time, the frames 0 to 2 for the ch1 and the frames 0 to 2 for the ch3 are stored in the frame memory. That is to say, the data for displaying the ch1 digital broadcasting screen and the data for displaying the ch3 analog broadcasting screen are disposed in the frame memory. In this case, the frame memory is commonly used for processing the digital broadcasting and the analog processing.

In such a case, the ch1 system clock and the ch3 system clock are input into the selector 42.

If the ch1 is assumed to be the master stream, the selector 42 selects the ch1 system clock, that is to say, the system clock supplied from the VCO 28, and outputs it to the comparator 43. Thus, the synchronization-signal generation section 45 generates the decode start signal and the display synchronization signal on the basis of the ch1 system clock.

When the ch1 is assumed to be the master stream, it becomes necessary for the ch3 analog signal to have frame synchronization processing. In such a case, there is a free space for processing 1-channel digital broadcasting in the frame memory necessary for performing the MPEG decoding processing as shown in FIG. 4. Accordingly, the frame synchronization processing can be performed using that part, and thus the frame memory can be shared both by the digital broadcasting and the analog broadcasting, making it possible to save memory.

When the ch2 is assumed to be the master stream, the processing is the same. The selector 42 selects the ch2 system clock, that is to say, the system clock supplied from the VCO 38, and outputs it to the comparator 43. Thus, the synchronization-signal generation section 45 generates the decode start signal and the display synchronization signal on the basis of the ch2 system clock.

When the ch2 is assumed to be the master stream, the video signal is output to the ch3 analog signal in synchronism with the input frame rate, and the same processing as the above-described case is performed on the ch1 digital signal. In this case, the state is as shown in FIG. 4, and thus the frame memory can be shared both by the digital broadcasting and the analog broadcasting, making it possible to save memory.

Next, a description will be given of the case where the ch3 image and the ch4 image are displayed on one screen, that is to say, 2-chnnel images of analog broadcasting are displayed on the same screen. In this case, the basic operations include the same operation of the case where 2-channel digital broadcasting are displayed on one screen as described above, and thus a brief description will be given on that part.

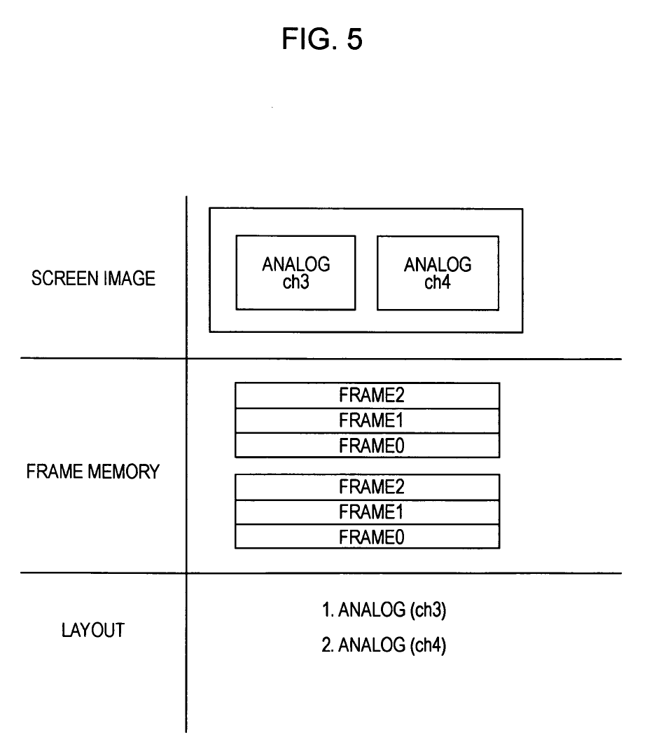

In this case, as shown in FIG. 5, the screen image is in a state in which the ch3 image of the analog broadcasting and the ch4 image of the analog broadcasting are displayed on the same screen. Also, at this time, the frames 0 to 2 for the ch3 and the frames 0 to 2 for the ch4 are stored in the frame memory. That is to say, the data for displaying the ch3 analog broadcasting screen and the data for displaying the ch4 analog broadcasting screen are disposed in the frame memory. In this case, the frame memory is commonly used for the analog processing.

In such a case, the ch3 system clock and the ch4 system clock are input into the selector 42.

If the ch3 is assumed to be the master stream, the selector 42 selects the ch3 system clock, that is to say, the system clock supplied from the VCO 38, and outputs it to the comparator 43. Thus, the synchronization-signal generation section 45 generates the decode start signal and the display synchronization signal on the basis of the ch3 system clock. If the ch4 is assumed to be the master stream, the same operations are performed in individual parts.

In this manner, when two analog sources are displayed on the same screen, it is not necessary to process digital broadcasting data, and thus the MPEG decoding itself is not necessary to be performed. Accordingly, the capacity of the frame memory can be used for frame synchronization, that is to say, as a memory for processing on analog broadcasting.

In this regard, in the above-described embodiment, a description has been given of the case using the MPEG method as decoding processing. However, it is possible to apply another decoding method.

In this manner, in the present embodiment, an image processing apparatus has a block (for example, a block including an STC counter 26, a comparator 27, and a VOC 28) which decodes a plurality of digital (MPEG2/AVC, etc.) sources, and a block (for example, a block including a Sync counter 36, a comparator 37, and a VOC 38) which decodes a plurality of analog video signals, and the plurality of blocks have individual clock recovery functions independently.

Also, the image processing apparatus has the synchronization-signal generation section 45 which generates a clock independently of a clock locked with each input source. The synchronization-signal generation section 45 can obtain a synchronization with the clock of the input source selected by the selector 42 out of a plurality of input sources. Thus, it becomes possible to continue to supply a display clock and a synchronization signal constantly and stably against changes of input sources and sudden variations such as a signal interrupt, etc. Also, when the display clock master is changed, the display synchronization signal is locked with each input source by a PLL, and thus it becomes possible to obtain a synchronization without causing the occurrence of a discontinuous synchronization signal.

Also, it becomes possible to share a digital-signal decoding memory and a frame transfer memory of analog signals, and thus it becomes possible to reduce memory, thereby making it possible to have a simple configuration.

About a Recording Medium

The above-described series of processing can be executed by hardware or can be executed by software. When the series of processing is executed by software, the programs constituting the software are built in a dedicated hardware of a computer. Alternatively, the various programs are installed, for example in a general-purpose personal computer capable of executing various functions from a program recording medium.

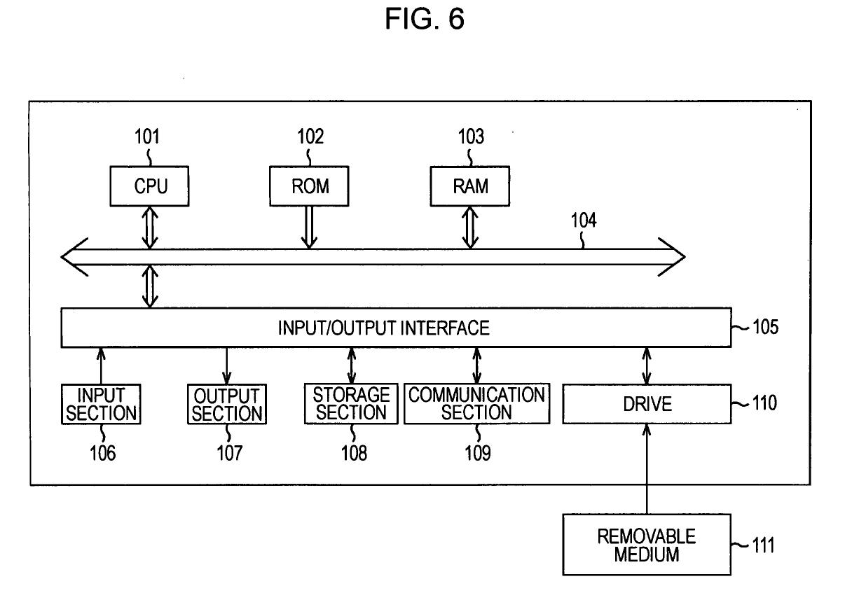

FIG. 6 is a block diagram illustrating an example of a configuration of computer hardware performing the above-described series of processing.

In the computer, a CPU (Central Processing Unit) 101, a ROM (Read Only Memory) 102, a RAM (Random Access Memory) 103 are mutually connected by a bus 104.

An input/output interface 105 is also connected to the bus 104. An input section 106 including a keyboard, a mouse, a microphone, etc., an output section 107 including a display, a speaker, etc., a storage section 108 including a hard disk, a nonvolatile memory, etc., a communication section 109 including a network interface, etc., and a drive 110 for driving a removable medium 111, such as a magnetic disk, an optical disc, a magneto-optical disc, or a semiconductor memory, etc., are connected to the input/output interface 105.

In the computer having the configuration as described above, the CPU 101 loads the program stored, for example in storage section 108 to the RAM 103 through the input/output interface 105 and the bus 104 to execute the program, thereby the above-described series of processing is performed.

The program to be executed by the computer (CPU 101) is recorded in a removable medium 111, which is a package medium including, such as a magnetic disk (including a flexible disk), an optical disc (including a CD-ROM (Compact Disc-Read Only Memory), a DVD (Digital Versatile Disc), etc.), a magneto-optical disc, or a semiconductor memory, etc. Alternatively, the program may be provided through wired or wireless transmission, such as a local area network, the Internet, a digital satellite broadcasting, etc.

The program can be installed in the storage section 108 through the input/output interface 105 by attaching the removable medium 111 to the drive 110. Also, the program can be received by the communication section 109 through wired or wireless transmission and be installed in the storage section 108. In addition, the program may be pre-installed in the ROM 102 or the storage section 108 in advance.

In this regard, the program executed by the computer may be the program that is processed in time series in accordance with the described sequence in this specification. Also, the programs may be the programs to be executed in parallel or at necessary timing, such as at the time of being called, or the like.

Also, in this specification, a system implies an overall apparatus including a plurality of apparatuses.

In this regard, an embodiment of the present invention is not limited to the embodiments described above, and various modifications are possible without departing from the spirit and scope of the present invention.

What is claimed is:

1. An image processing apparatus comprising:
digital-source processing means for processing a plurality of digital sources;
analog-source processing means for processing a plurality of analog sources; and
generation means for generating a clock independently of a clock locked with each input source of the digital sources and the analog sources, and generating a clock in synchronism with a clock selected out of the input sources,
wherein the digital-source processing means and the analog-source processing means have individual clock recovery functions independently.

2. The image processing apparatus according to claim 1, further comprising synthesizing means performing processing for synthesizing a plurality of images out of images based on the plurality of digital sources and images based on the plurality of analog sources,
wherein a clock and a synchronization signal of the synthesizing means uses the clock generated by the generation means as a source.

3. The image processing apparatus according to claim 1,
wherein the generation means generates a decode start signal specifying timing of decoding the digital source and a display synchronization signal.

4. The image processing apparatus according to claim 1,
wherein a decode memory used when decoding the digital source and a memory for transferring frames of the analog source are shared.

5. A method of processing an image, comprising the steps of:
controlling digital source processing of a plurality of digital sources;
controlling analog source processing of a plurality of analog sources;
controlling generation of a clock independently of a clock locked with each input source of the digital sources and the analog sources, and generation of a clock in synchronism with a clock selected out of the input sources,
wherein the step of controlling digital source processing and the step of controlling analog source processing control individual clock recovery functions independently.

6. A program for causing a computer to perform image processing, the processing comprising the steps of:
controlling digital source processing of a plurality of digital sources;
controlling analog source processing of a plurality of analog sources;
controlling generation of a clock independently of a clock locked with each input source of the digital sources and the analog sources, and generation of a clock in synchronism with a clock selected out of the input sources,
wherein the step of controlling digital source processing and the step of controlling analog source processing control individual clock recovery functions independently.

7. A recording medium for recording the program according to claim 6.

8. An image processing apparatus comprising:
a digital-source processing mechanism for processing a plurality of digital sources;
an analog-source processing mechanism for processing a plurality of analog sources; and
a generation mechanism for generating a clock independently of a clock locked with each input source of the digital sources and the analog sources, and generation of a clock in synchronism with a clock selected out of the input sources,
wherein the digital-source processing mechanism and the analog-source processing mechanism have individual clock recovery functions independently.
